(19) United States
(12) Patent Application Publication
(10) Pub. No.: US 2008/0303438 A1
(43) Pub. Date: Dec. 11, 2008

(54) Plasma display panel

(76) Inventors: Hyun Soh, Suwon-si (KR); Joong-Ho Moon, Suwon-si (KR); Jin-Won Han, Suwon-si (KR); Jung-Keun Ahn, Suwon-si (KR)

Correspondence Address: ROBERT E. BUSHNELL, 1522 K STREET NW, SUITE 300, WASHINGTON, DC, 20005-1202, US

(21) Appl. No.: 12/155,462

(22) Filed: Jun. 4, 2008

(30) Foreign Application Priority Data
Jun. 7, 2007 (KR) 10-2007-0055723

(51) Int. Cl. H01J 17/49

(52) U.S. Cl. 313/582

(57) ABSTRACT

Provided is a plasma display panel (PDP). The PDP includes first and second substrates which face each other with a predetermined gap, barrier ribs which are disposed between the first and second substrates and define discharge cells, discharge electrodes which are disposed between the first and second substrates and have different widths, phosphor layers which are formed in the discharge cells, and colored layers which colors the phosphor layers of the discharge cells. Specifically, a red colored layer colors the red phosphor layer and a blue colored layer colors the blue phosphor layers, while the green phosphor layers are not colored.

### CLAIM OF PRIORITY

This application makes reference to, incorporates the same herein, and claims all benefits accruing under 35 U.S.C. §119 from an application for PLASMA DISPLAY PANEL earlier filed in the Korean Intellectual Property Office on the 7th of Jun. 2007 and there duly assigned Serial No. 10-2007-0055723.

### BACKGROUND OF THE INVENTION

1. Field of the Invention

The present invention relates to a plasma display panel (PDP), and more particularly, to a PDP in which a bright room contrast and brightness are improved by improving structures of phosphor layers and discharge electrodes.

2. Description of the Related Art

A plasma display panel (PDP) is a display device that displays desired numbers, characters, or graphic images. A discharge gas is injected between two substrates on which a plurality of electrodes is formed, and the substrates are sealed. Appropriate address pulses and sustain pulse are applied to the electrodes to select discharge cells and to excite the discharge gas of the selected discharge cells. The selected discharge cells emit light.

A three-electrode surface discharge type PDP is manufactured by preparing first and second substrates, forming pairs of sustain discharge electrodes having X and Y electrodes on an inner surface of the first substrate, forming a first dielectric layer in order to cover the pairs of the sustain discharge electrodes, forming a protective layer on a surface of the first dielectric layer, forming address electrodes on an inner surface of the second substrate crossing the pairs of sustain discharge electrodes, forming a second dielectric layer in order to cover the address electrodes, disposing barrier ribs between the first and second substrate in order to define discharge cells, and forming red, green, and blue phosphor layers in the discharge cells.

In the above-described PDP, discharge cells, from which light is to be emitted, are selected by applying an electric signal to the address electrode and the Y electrodes of the discharge cells. If sustain electric signals are alternatively applied to the X and Y electrodes, visible light is emitted from phosphors of the phosphor layers that are formed in the selected discharge cells. Thus, a still image or a moving image may be displayed.

Regarding characteristics of the materials of the phosphors, even though the phosphor layers emit specific colors if the phosphors are activated, the phosphor layers has white color while the phosphors are not activated. Therefore, during the operation of the PDP, the discharge cells, which are not activated, produce white color. Thus, a bright room contrast of the PDP deteriorates. Accordingly, various methods for preventing the deterioration of the bright room contrast have been proposed, but these methods mostly cause reduction of the brightness of the PDP. Therefore a solution for this issue, which improves the bright room contrast as well as the brightness of the PDP, is necessary.

### SUMMARY OF THE INVENTION

The present invention provides a plasma display panel (PDP) in which bright room contrast and brightness are improved by using colored layers together with white phosphor layers and diversifying the width of discharge electrodes.

According to an aspect of the present invention, there is provided a plasma display panel (PDP) including a first substrate, a second substrate facing the first substrate, a plurality of barrier ribs which are disposed between the first and second substrates and defines a plurality of discharge cells, a plurality of discharge electrodes which are disposed between the first and second substrates, a plurality of phosphor layers, each of which is formed in one of the discharge cells, and a plurality of colored layers, each of which is coupled to one of the phosphor layers to provide a color. A width of at least one of the discharge electrodes is different from a width of another of the discharge electrodes.

The phosphor layers may include a red phosphor layer that emits red color when activated, a green phosphor layer that emits green color when activated, and a blue phosphor layer that emits blue color when activated. The colored layers may include a red colored layer and a blue colored layer. The red colored layer is coupled to the red phosphor layer and the blue colored layer is coupled to the blue phosphor layer.

An appearance color of each of the red, green, and blue phosphor layers may be substantially white.

An appearance color of the -red colored layer may be red, and an appearance color of the blue colored layer may be blue.

A raw material of the red phosphor layer may be doped with the red colored layer, and a raw material of the blue phosphor layer may be doped with the blue colored layer.

The red phosphor layers may be coated with the red colored layer, and the blue phosphor layers may be coated with the blue colored layer.

A width of address electrodes passing discharge cells on which the green phosphor layers are formed may be greater than a width of address electrodes passing discharge cells on which the red phosphor layers or the blue phosphor layers are formed.

According to another aspect of the present invention, there is provided a plasma display panel (PDP) including a first substrate, a second substrates facing the first substrate, a plurality of barrier ribs which are disposed between the first and second substrates and defines discharge cells, a plurality of discharge electrodes which are disposed between the first and second substrates, a plurality of phosphor layers, each of which is formed in one of the discharge cells, and a plurality of colored layers, each of which is coupled to one of the phosphor layers. Appearance colors of the phosphor layers are substantially white, and each of the colored layers has a specific appearance color. A width of at least one of the discharge electrodes is different from a width of another of the discharge electrodes.

The phosphor layers may include a red phosphor layer that emits red color when activated, a green phosphor layer that emits green color when activated, and a blue phosphor layer that emits blue color when activated. The colored layers may include a red colored layer and a blue colored layer. The red colored layer is coupled to the red phosphor layer and the blue colored layer is coupled to the blue phosphor layer.

A raw material of the red phosphor layers may be doped with the red colored layer, and a raw material of the blue phosphor layers may be doped with the blue colored layer.

The red phosphor layers may be coated with the red colored layer, and the blue phosphor layers may be coated with the blue colored layer.

A width of discharge electrodes of discharge cells on which the green phosphor layers are formed may be greater than a width of discharge electrodes of discharge cells on which the red phosphor layers or the blue phosphor layers are formed.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is an exploded perspective view of a portion of a plasma display panel (PDP) according to an embodiment of the present invention;

FIG. 2 is a cross-sectional view of the PDP illustrated in FIG. 1 taken along a line I-I, according to an embodiment of the present invention; and

FIG. 3 is a cross-sectional view of a PDP according to another embodiment of the present invention.

### DETAILED DESCRIPTION OF THE INVENTION

Hereinafter, the present invention will be described in detail by explaining embodiments of the invention with reference to the attached drawings. Like reference numerals denote like elements in the drawings.

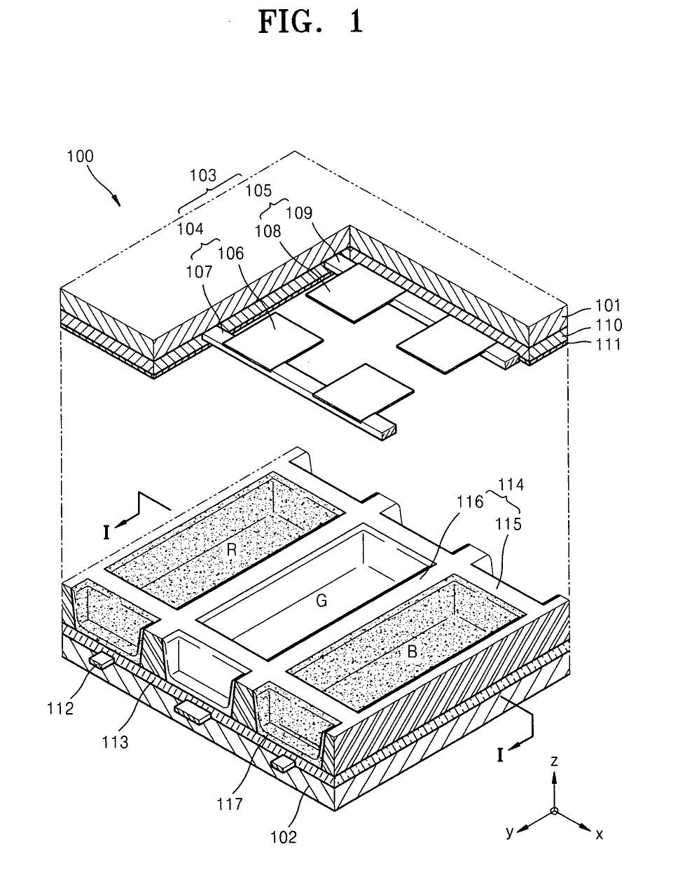

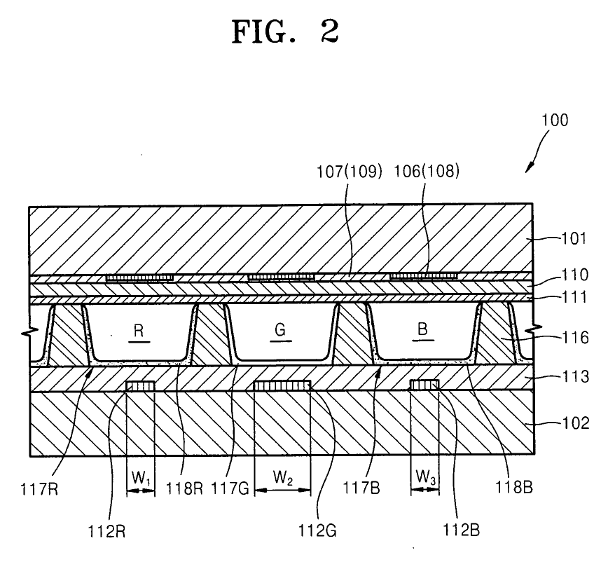

FIG. 1 is an exploded perspective view of a portion of a plasma display panel (PDP) 100 according to an embodiment of the present invention. FIG. 2 is a cross-sectional view of the PDP 100 illustrated in FIG. 1 taken along a line I-I, according to an embodiment of the present invention.

Referring to FIGS. 1 and 2, the PDP 100 includes a first substrate 101 and a second substrate 102 that is disposed in parallel with the first substrate 101. Frit glass (not shown) is formed along edges of inner surfaces of the first and second substrates 101 and 102 which face each other so that a discharge space of the PDP 100 is sealed.

The first substrate 101 may be a transparent substrate such as a soda lime glass substrate. Alternatively, the first substrate 101 may be a semi-transparent substrate, a colored substrate, or a reflective substrate.

Sustain discharge electrodes 103, each of which includes an X electrode 104 and a Y electrode 105, are disposed on an inner surface of the first substrate 101 along an x direction as shown in FIG. 1. The X and Y electrodes 104 and 105 are alternatively disposed along a y direction. A set of the X and Y electrodes 104 and 105 is disposed on each discharge cell.

The X electrode 104 includes X transparent electrodes 106 that are independently disposed on discharge cells, and an X bus electrode 107 that electrically connects the X transparent electrodes 106 to each other, which are independently disposed in neighboring discharge cells arranged in the x direction. According to the present invention, each of the X transparent electrodes 106 has a square shaped cross section, and the X bus electrode 107 has a strip shaped cross section. However, the shapes of the electrode are not limited thereto.

The Y electrode 105 includes Y transparent electrodes 108 that are independently disposed on discharge cells, and a Y bus electrode 109 that electrically connects the Y transparent electrodes 108 to each other, which are independently disposed in neighboring discharge cells arranged in the x direction. Shapes of the X and Y electrodes 104 and 105 are substantially the same.

In this case, the X and Y transparent electrodes 106 and 108 are disposed above the centers of discharge cells being separated by a predetermined distance, and discharge gaps are formed between the X and Y transparent electrodes 106 and 108.

Also, the X and Y transparent electrodes 106 and 108 may be formed of a transparent conductive film, such as indium tin oxide (ITO) film, in order to improve an aperture ratio of the first substrate 101. The X and Y bus electrodes 107 and 109 may be formed of a conductive metallic material, such as a multi-layer of an Ag paste or a Cr—Cu—Cr alloy, in order to improve electric conductivity of the X and Y transparent electrodes 106 and 108.

Space between a set of X and Y electrodes 104 and 105 and another neighboring set of X and Y electrodes 104 and 105 corresponds to a non-discharge region. In the non-discharge region, a black stripe layer (not shown) may be further formed in order to improve the contrast of the PDP 100.

The X and Y electrodes 104 and 105 are covered by a first dielectric layer 110. The first dielectric layer 110 may be composed of a high-k (high dielectric constant) material such as ZnO—B₂O₃—Bi₂O₃. The first dielectric layer 110 may be selectively printed on the pairs of sustain discharge electrodes 103 or may be printed on the whole internal surface of the first substrate 101.

A protective layer 111 composed of, for example MgO, is deposited on a surface of the first dielectric layer 110 in order to protect the first dielectric layer 110 from being damaged and to increase an amount of secondary emission.

The second substrate 102 may be substantially the same as the first substrate 101. Address electrodes 112 are disposed on an inner surface of the second substrate 102 so as to cross the sustain discharge electrodes 103. The address electrodes 112 are covered by a second dielectric layer 113. The second dielectric layer 113 may be composed of a high-k material such as PbO—B₂O₃—SiO₂. Any of the address electrodes 112, X electrode 104, and the Y electrode 105 can be referred to as a discharge electrode.

Barrier ribs 114 are disposed between the first and second substrates 101 and 102 so as to define the discharge cells together with the first and second substrates 101 and 102. The barrier ribs 114 include first barrier ribs 115 disposed in the X direction and second barrier ribs 116 disposed in the Y direction, and define the barrier ribs 114 which are a lattice type.

The barrier ribs 114 may be a meander type, a delta type, a waffle type, a honeycomb type, or the like. Also, according to the current embodiment, a cross section of discharge regions defined by the barrier ribs 114 may be a square. However, the cross section of the discharge regions may also be a triangle, a polygon such as a pentagon, or the like.

Meanwhile, a discharge gas such as Ne—Xe or He—Xe is injected into the discharge cells defined by the first and second substrates 101 and 102 and the barrier ribs 114.

Also, phosphor layers 117 which emit visible light by being excited by ultraviolet light generated from the discharge gas are formed in the discharge cells. The phosphor layers 117 may be formed on any region of the discharge cells. According to the current embodiment, the phosphor layers 117 are formed to a predetermined thickness on the inner surface of the first substrate 101 and on inner walls of the barrier ribs 114.

Here, at least one of the phosphor layers 117 is colored and at least one of discharge electrodes, such as the X and Y electrodes 104 and 105, and the address electrodes 112 are formed so as to have different widths compared to each other.

In more detail, the barrier ribs 114 which define the discharge cells are disposed between the first and second substrates 101 and 102. The barrier ribs 114 are composed of a dielectric material that may induce charges when the discharge cells are discharged. Preferably, the barrier ribs 114 are constructed by adding an organic vehicle and various fillers to glass powder.

The phosphor layers 117 are formed in the discharge cells defined by the barrier ribs 114. According to the current embodiment, the phosphor layers 117 include red phosphor layers 117R, green phosphor layers 117G, and blue phosphor layers 117B. Herein, the red phosphor layer 117R means the red phosphor layer emit red color when excited (or activated) by ultraviolet light. In the same manner, green phosphor layer 117G emits green color when activated, and blue phosphor layer emits blue color when activated. However, the present invention is not limited thereto. The phosphor layers 117 having different colors may be substituted or added.

According to the current embodiment, the red phosphor layers 117R may be composed of (Y,Gd)BO₃;Eu⁺³, the green phosphor layers 117G may be composed of Zn₂SiO₄:Mn²⁺, and the blue phosphor layers 117B may be composed of BaMgAl₁₀O₁₇:Eu²⁺. The blue phosphor layers 117B may be composed of CaMgSi₂O₈:Eu²⁺ or a compound of BaMgAl₁₀O₁₇:Eu²⁺ and CaMgSi₂O₈:Eu²⁺.

In appearance, color of each of the red phosphor layers 117R, the green phosphor layers 117G, and the blue phosphor layers 117B is substantially white. Herein, it should be noted that the appearance color is the color of the material, and is different from an emitting color. For example, the red phosphor layer 117R may have white appearance color, but emits red color when activated by ultraviolet rays. In this case, the emitting color of the red phosphor layer is red while the appearance color of the red phosphor layer is white. If not specifically described, the color in this specification means the appearance color.

In this case, a red colored layer 118R and a blue colored layer 118B are coupled to each of the red phosphor layers 117R and the blue phosphor layers 117B, respectively, in order to provide specific colors. In appearance, the colors of the red colored layer 118R and the blue colored layer 118B are red and blue, respectively.

In one embodiment, the red colored layer 118R can be coupled to the red phosphor layer 117R by doping the raw material of the red phosphor layer 117R with the red colored layer 118R In the same manner, the blue colored layer 118B can be coupled to the blue phosphor layer 117B by doping the raw materials of the blue phosphor layers 117B with the blue colored layer 118B. The red colored layer 118R includes a red pigment having Fe₂O₃, and the blue colored layer 118B includes a blue pigment having Co₂O₃.

On the other hand, the green phosphor layers 117G are not coupled to anything such as a green colored layer. As brightness is more affected by green color rather than red or blue color, even though the red colored layers 118R and the blue colored layers 118B are coupled to the red phosphor layers 117R and the blue phosphor layers 117B, reduction of the brightness of the PDP during operation can be minimized, because a green colored layer is not coupled to the green phosphor layers 117G.

The red phosphor layers 117R coupled with the red colored layers 118R, the green phosphor layers 117G, and the blue phosphor layers 117B coupled with the blue colored layers 118B are formed on the inner walls of the barrier ribs 114 and on a surface of the second dielectric layer 113.

Meanwhile, the brightness of the whole PDP 100 may be reduced by applying the red colored layers 118R and the blue colored layers 118B. In order to prevent the decrease of the brightness, a width of the address electrodes 112 passing discharge cells, on which colored layers are not formed, is different from the width of the address electrodes 112 passing discharge cells, on which the colored layers are formed.

That is, a width W₂ of green address electrodes 112G passing green discharge cells on which the colored layers are not formed is relatively wider than a width W₁ of red address electrodes 112R passing red discharge cells on which red phosphor layers 117R are colored by the red colored layers 118R or a width W₃ of blue address electrodes 112B passing blue discharge cells on which the blue phosphor layers 117B are colored by the blue colored layers 118B.

By forming the width W₂ of the green address electrodes 112G to be relatively wider than the width W₁ of the red address electrodes 112R or the width W₃ of the blue address electrodes 112B, various advantages may be obtained as described below.

The address electrodes 112 include a metallic component such as an Ag paste that has excellent reflectivity. Thus, due to the red colored layers 118R and the blue colored layers 118B, the brightness decreases on the red discharge cells on which red phosphor layers 117R are formed or on the blue discharge cells on which the blue phosphor layers 117B are formed. On the other hand, reflection of external light may be maximized on the green discharge cells on which the green phosphor layers 117G, not colored by any colored layer, are formed. Accordingly, the brightness of the whole PDP 100 may be improved.

In this case, reflective brightness may be efficiently improved if the width W₂ of the green address electrodes 112G on the green discharge cells on which the green phosphor layers 117G are formed is greater than ½ of the width of discharge cells. Herein a width of a discharge cell is defined along the same direction as the width of the electrode. Therefore, a width direction is perpendicular to a direction along which the electrode extends as shown in FIG. 2.

Operations of the above-described PDP 100 will now be described.

First, if a predetermined pulse voltage is applied between the address electrodes 112 and the Y electrodes 105 from an external source, discharge cells to be emitted are selected. Wall charges are stored on inner surfaces of the selected discharge cells.

Then, if a “+”voltage is applied to the X electrodes 104 and a relatively higher voltage than the “+”voltage is applied to the Y electrodes 106, the wall charges are transferred due to-a voltage gap between the X and Y electrodes 104 and 105.

Due to the transferring of the wall charges, the wall charges collide against atoms of the discharge gas so as to cause a discharge to occur and to generate plasma. The discharge is started by a discharge gap between the X and Y transparent electrodes 106 and 108 in which relatively strong electric fields are formed, and is extended to the X and Y bus electrodes 107 and 109.

After the discharge occurs, if the voltage gap between the X and Y electrodes 104 and 105 is lower than a discharge voltage, the discharge is not generated any more and space charges and the wall charges are formed in the discharge cells.

In this case, if polarities of voltages applied to the X and Y electrodes 104 and 105 are switched, the discharge is reformed by the support of the wall charges. By switching the polarities of the X and Y electrodes 104 and 105, the discharge that is initially formed is repeated. By repeating the above described procedures, the discharge is stably formed.

Meanwhile, the ultraviolet light generated by the discharge excites phosphors of the red phosphor layers 117R, the green phosphor layers 117G, and the blue phosphor layers 117B which are formed on each of the discharge cells. Visible light is generated from the phosphor layers. The generated visible light emits from the discharge cells so as to display a still image or a moving image.

In this case, the red phosphor layers 117R colored by the red colored layers 118R or the blue phosphor layers 117B colored by the blue colored layers 118B are formed on discharge cells on which the discharge is not formed. Thus, the bright room contrast of the PDP 100 is improved. Also, the width W₂ of the green address electrodes 112G is relatively wider than the width W₁ of the red address electrodes 112R or the width W₃ of the blue address electrodes 112B on discharge cells on which the green phosphor layers 117G not colored by a green colored layer are formed. Thus, the brightness of the whole PDP 100 is improved.

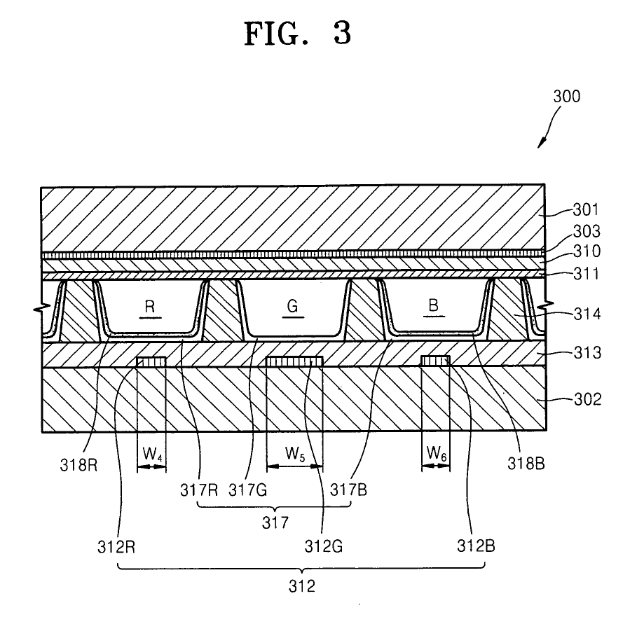

FIG. 3 is a cross-sectional view of a PDP 300 according to another embodiment of the present invention. Referring to FIG. 3, the PDP 300 includes a first substrate 301 and a second substrate 302 that is disposed in parallel with the first substrate 301.

Sustain discharge electrodes 303 are disposed on an inner surface of the first substrate 301 along a direction. The sustain discharge electrodes 303 are covered by a first dielectric layer 310. A protective layer 311 is deposited on a surface of the first dielectric layer 310.

Address electrodes 312 are disposed on an inner surface of the second substrate 302 so as to cross the sustain discharge electrodes 303. The address electrodes 312 are covered by a second dielectric layer 313.

Barrier ribs 314 are disposed between the first and second substrates 301 and 302 so as to define discharge cells together with the first and second substrates 301 and 302. Phosphor layers 317 are formed in the discharge cells defined by the barrier ribs 314. The phosphor layers 317 include red phosphor layers 317R, green phosphor layers 317G, and blue phosphor layers 317B.

In this case, red colored layers 318R and blue colored layers 318B are formed on the red phosphor layers 317R and the blue phosphor layers 317B, respectively, in order to provide specific appearance colors.

In this embodiment, the red phosphor layers 317R and the blue phosphor layers 317B are coated with the red colored layers 318R and the blue colored layers 318B, respectively. The red colored layers 318R include a red pigment having Fe₂O₃, and the blue colored layers 318B include a blue pigment having Co₂O₃. On the other hand, any layer is not formed on the green phosphor layers 317G.

Also, a width W₅ of green address electrodes 312G of green discharge cells, on which a colored layer is not formed, is relatively wider than a width W₄ of red address electrodes 312R of red discharge cells, on which the red phosphor layers 317R are coated with the red colored layer 318R, or a width W₆ of blue address electrodes 312B of blue discharge cells, on which the blue phosphor layers 317B are coated with the blue colored layer 318B.

The red phosphor layers 317R coated with the red colored layers 318R or the blue phosphor layers 317B coated with the blue colored layers 318B are formed on discharge cells in which a discharge does not occur while the PDP 300 operates. Thus, the bright room contrast of the PDP 300 is improved. Also, the width W₅ of the green address electrodes 312G is relatively wider than the width W₄ of the red address electrodes 312R or the width W₆ of the blue address electrodes 312B on discharge cells on which the green phosphor layers 317G are not coated with the green colored layers. Thus, brightness of the whole PDP 300 is improved.

As described above, according to the present invention, the bright room contrast of a PDP may be improved by using colored layers together with white phosphor layers. Furthermore, brightness of a whole PDP maybe improved by forming discharge electrodes having a larger width on discharge cells on which white phosphor layers are formed than a width of discharge electrodes on discharge cells on which colored phosphor layers are formed.

While the present invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A plasma display panel (PDP) comprising:
a first substrate;
a second substrate facing the first substrate;
a plurality of barrier ribs which are disposed between the first and second substrates, the barrier ribs defining a plurality of discharge cells;
a plurality of discharge electrodes which are disposed between the first and second substrates, a width of at least one of the discharge electrodes being different from a width of another of the discharge electrodes;
a plurality of phosphor layers, each of which is formed in one of the discharge cells; and
a plurality of colored layers, each of which is coupled to one of the phosphor layers to provide a color.

2. The PDP of claim 1, wherein:
the phosphor layers comprise a red phosphor layer that emits red color when activated, a green phosphor layer that emits green color when activated, and a blue phosphor layer that emits blue color when activated; and
the colored layers includes a red colored layer and a blue colored layer, the red colored layer being coupled to the red phosphor layer and the blue colored layer being coupled to the blue phosphor layer.

3. The PDP of claim 2, wherein an appearance color of each of the red, green, and blue phosphor layers is substantially white.

4. The PDP of claim 2, wherein an appearance color of the red colored layer is red, and an appearance color of the blue colored layer is blue.

5. The PDP of claim 4, wherein the red colored layer include Fe₂O₃.

6. The PDP of claim 4, wherein the blue colored layer include Co₂O₃.

7. The PDP of claim 2, wherein a raw material of the red phosphor layers is doped with the red colored layer, and a raw material of the blue phosphor layers is doped with the blue colored layer.

8. The PDP of claim 2, wherein the red phosphor layers are coated with the red colored layer, and the blue phosphor layers are coated with the blue colored layer.

9. The PDP of claim 2, further comprising a dielectric layer formed on the second substrate, the phosphor layers being formed on inner walls of the barrier ribs and on a surface of the dielectric layer.

10. The PDP of claim 2, wherein the discharge electrodes comprise sustain discharge electrodes disposed in a direction, and address electrodes disposed in another direction crossing the direction of the sustain discharge electrodes.

11. The PDP of claim 10, wherein a width of address electrodes that pass the discharge cells formed with the green phosphor layer is greater than a width of address electrodes that pass the discharge cells formed with the red phosphor layer or the blue phosphor layer.

12. The PDP of claim 10, wherein a width of address electrodes that pass the discharge cells formed with the green phosphor layer is greater than half a width of the corresponding discharge cells.

13. A plasma display panel (PDP) comprising:
a first substrate;
a second substrates facing the first substrate;
a plurality of barrier ribs which are disposed between the first and second substrates, the barrier ribs defining discharge cells;
a plurality of discharge electrodes which are disposed between the first and second substrates, a width of at least one of the discharge electrodes being different from a width of another of the discharge electrodes;
a plurality of phosphor layers, each of which is formed in one of the discharge cells, appearance colors of the phosphor layers being substantially white; and
a plurality of colored layers, each of which is coupled to one of the phosphor layers, each of the colored layers having a specific appearance color.

14. The PDP of claim 13, wherein the phosphor layers comprise a red phosphor layer that emits red color when activated, a green phosphor layer that emits green color when activated, and a blue phosphor layer that emits blue color when activated; and wherein the colored layers comprise a red colored layer and a blue colored layer, the red colored layer being coupled to the red phosphor layer and the blue colored layer being coupled to the blue phosphor layer.

15. The PDP of claim 14, wherein the red colored layers include Fe₂O₃.

16. The PDP of claim 14, wherein the blue colored layers include Co₂O₃.

17. The PDP of claim 14, wherein a raw material of the red phosphor layers is doped with the red colored layer, and a raw material of the blue phosphor layers is doped with the blue colored layer.

18. The PDP of claim 14, wherein the red phosphor layers are coated with the red colored layer, and the blue phosphor layers are coated with the blue colored layer.

19. The PDP of claim 14, wherein a width of discharge electrodes of discharge cells on which the green phosphor layers are formed is greater than a width of discharge electrodes of discharge cells on which the red phosphor layers or the blue phosphor layers are formed.

20. The PDP of claim 19, wherein the width of the discharge electrodes of the discharge cells on which the green phosphor layers are formed is greater than ½ of a width of the corresponding discharge cells.
